(19) United States
(12) Patent Application Publication
(10) Pub. No.: US 2005/0267678 A1
(43) Pub. Date: Dec. 1, 2005

(54) Traveled point display device and program

(75) Inventor: Wataru Sugiura, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/137,391

(22) Filed: May 26, 2005

(30) Foreign Application Priority Data
Jun. 1, 2004 (JP) 2004-163511

(51) Int. Cl. G01C 21/30

(52) U.S. Cl. 701/208; 340/995.1

(57) ABSTRACT

A traveled point display device determines based on map data a kind of a road that a subject vehicle travels to thereby show a traveled point in a display form corresponding to the kind of the road. First traveled points of a local road are shown in red and in 100-m road intervals therebetween. Second traveled points of an inter-city expressway are shown in black and in 1-km road intervals therebetween. Third traveled points of an intra-city expressway are shown in grey and in 300-m road intervals therebetween. Displayed traveled points indicate which kind of the road the subject vehicle travels at a glance by their display colors and display intervals.

### CROSS REFERENCE TO RELATED APPLICATIONS

This application is based on and incorporates herein by reference Japanese Patent Application No. 2004-163511 filed on Jun. 1, 2004.

### FIELD OF THE INVENTION

The present invention relates to a display device for displaying traveled points of a vehicle.

### BACKGROUND OF THE INVENTION

There are known displaying technologies that display traveled points of subject vehicles on road maps as one function of a navigation device (Patent Documents 1 and 2). In these technologies, traveled points are shown in given distance intervals therebetween (in constant distance intervals). Further, there is another technology that finely shows traveled points when a speed or a direction of a vehicle changes largely or another technology that changes display intervals of traveled points depending on a vehicle speed (Patent Documents 3 and 4).

Furthermore, in Patent Document 5, traveled points are shown by shapes (>>>) representing a direction and an interval. This tries to solve the following problem. Namely, suppose that an expressway and a usual road are displayed in colors different from each other. Here, if these roads are painted entirely by traveled points, the kinds of the roads cannot be distinguished from each other. Therefore, this technology shows traveled points using shapes having significant intervals so that the colors of the roads can remain recognizable. The kinds of the roads can be thereby recognized. Further, in Patent Document 6, a color of a mark for the traveled point is changed depending on a speed.

Patent Document 1: JP-S58-28614 A (U.S. Pat. No. 4,532,514)

Patent Document 2: JP-H3-39779 A

Patent Document 3: JP-S57-186112

Patent Document 4: JP-H3-71015A

Patent Document 5: JP-H8-278749 A

Patent Document 6: JP-H9-72745 A

Although improving appearances of traveled points within a whole display, the above technologies do not teach a kind of a road that a subject vehicle travels. For instance, in Patent Document 5, displayed traveled points do not indicate a kind of a road. When a wide-area map is displayed, colors of roads per se are not easily recognizable on a displayed map. The road kinds cannot be thereby easily understood.

### SUMMARY OF THE INVENTION

It is an object of the present invention to display traveled points that enable rapid understanding of a kind of a road a subject vehicle travels.

To achieve the above object, a traveled point display device provided in a vehicle is provided with the following. A road map storing unit is included for storing map data that includes a road attribute including a kind of a road, and a lane number of the road. A displaying unit is included for displaying a road map based on the map data. A traveled point detecting unit is included for detecting a traveled point of the vehicle. A display controlling unit is included for changing a display form of the traveled point based on the road attribute so that the road attribute is visually distinguished, and for causing the display unit to display the traveled point in the display form changed.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a schematic structure of a navigation device according to an embodiment of the present invention;

FIG. 2 is a flowchart diagram showing a traveled point displaying process;

FIG. 3 is a flowchart diagram showing an inter-city-expressway traveled point displaying process;

FIG. 4 is a flowchart diagram showing an intra-city-expressway traveled point displaying process; and

FIG. 5 is an exemplified display view for showing traveled points.

### DETAILED DESCRIPTION OF THE PREFERRED EMBODIMENTS

(Explanation of Navigation Device)

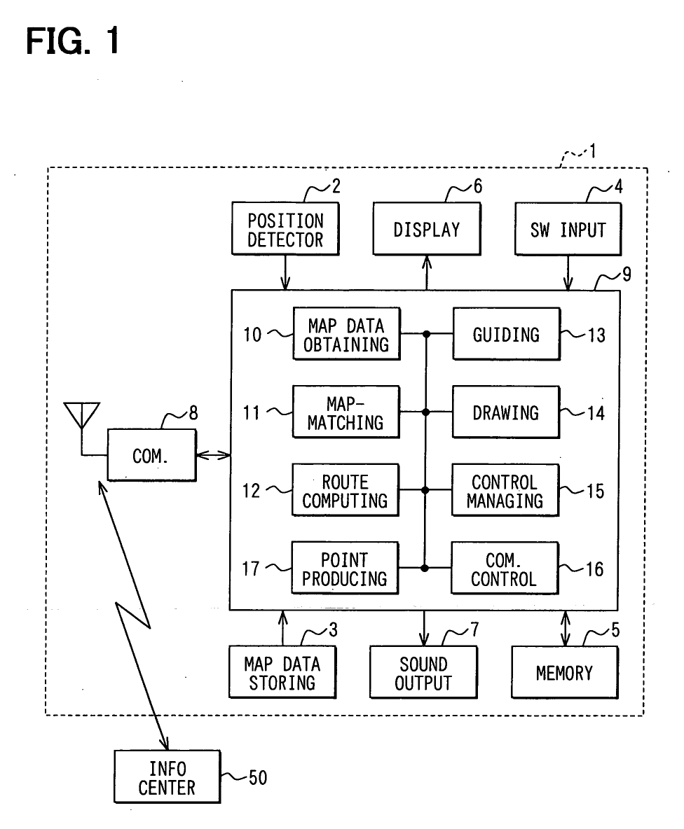

A traveled point display device according to an embodiment of the present invention is directed to a navigation device 1. The navigation device 1 is provided in a subject vehicle. As shown in FIG. 1, the navigation device 1 includes a position detector 2, a map data storing unit 3, a switching information input unit 4, a memory unit 5, a display unit 6, a sound output unit 7, a data communications unit 8, and a control unit 9.

The position detector 2 includes a GPS sensor, a gyroscope sensor, and a speed sensor for detecting a current position of the vehicle. As long as the current position can be detected, all the above sensors are not necessary and at least one of the sensors can suffice for this purpose. Here, the GPS sensor can accurately detect a current position of a vehicle, so the position detector 2 in this embodiment includes at least the GPS sensor.

The map data storing unit 3 is a DVD player, a hard disk drive, a CD player, or the like to store map data including road map information. In this road map information, a road number corresponds to each of roads; further, with respect to certain roads, a road number corresponds to each of road segments within the certain roads.

The switching information input unit 4 is attached to at least any one of the right, the left, the upper, and the lower of the display unit 6. A driver of the vehicle selects an operation or gives an instruction for various operations via the switching information input unit 4. The memory unit 5 includes a ROM, a RAM, and the like. The ROM stores programs for navigating and further executing various processes (to be explained later). The RAM includes a work memory and a region for temporarily storing map data or the like obtained from the map data storing unit 3.

The display unit 6 displays: a map used for navigating a driver; a traveled point (to be explained later); and a window for designating a destination. The sound output unit 7 outputs a sound for navigating a driver or explaining a display operation. The data communications unit 8 includes a bi-directional communications function to be a cell phone or a car phone.

The control unit 9 controls the above-described units in the navigation device 1 to include a map data obtaining unit 10, a map-matching unit 11, a route computing unit 12, a route guiding unit 13, a drawing unit 14, a display control managing unit 15, a communications control unit 16, and a traveled point producing unit 17. Operations of these units will be explained below.

The map data obtaining unit 10 obtains map data that is necessary for the units in the control unit 9 from the map data storing unit 3 to then provide the map data to the relevant units. Processes of the map data obtaining unit 10 and the other units of the control unit 9 are executed using the ROM or the RAM in the memory unit 5.

The map-matching unit 11 identifies on which road the current position is located, by using the current position detected by the position detector 2 and road shape data in the map data obtained from the map data storing unit 3. Here, necessary map data is obtained by the map data obtaining unit 10 from the map data storing unit 3.

The route computing unit 12 computes a route from the current position (or a departing point) to a destination. Here, the current position is computed by the map-matching unit 11; the departing point is designated by the driver; and the destination is designated by the driver to have a preferred map displayed using the switching information input unit 4. The route guiding unit 13 computes positional points necessary for guiding or necessary guiding (navigating such as instructions for turning to the right or the left, or the like). The positional points are computed from a result of the route computing, road shape data, positional information of intersections or crossings, or the like.

The drawing unit 14 draws a map around the current position, a schematic drawing of an expressway, or an enlarged map around an intersection that the subject vehicle approaches to thereby display it on the display unit 6. The traveled point producing unit 17 produces traveled points of the subject vehicle based on positional data from the position detector 2. Here, as explained later, the traveled points are displayed in a form differentiated based on a kind of a road that the subject vehicle travels. This display control is also executed by the traveled point producing unit 17.

The communications control 16 instructs the data communications unit 8 to be prepared for communicating with an information center 50 when the driver gives an instruction using the switching information input unit 4 or when a given time period elapses. Thereby, a request for distributing information can be outputted to the information center 50, and relevant information that is sent from the information center 50 based on the request can be received and to be stored in the memory unit 5. The information center 50 distributes information that includes application programs or map data.

(Explanation of Traveled Point Displaying Process)

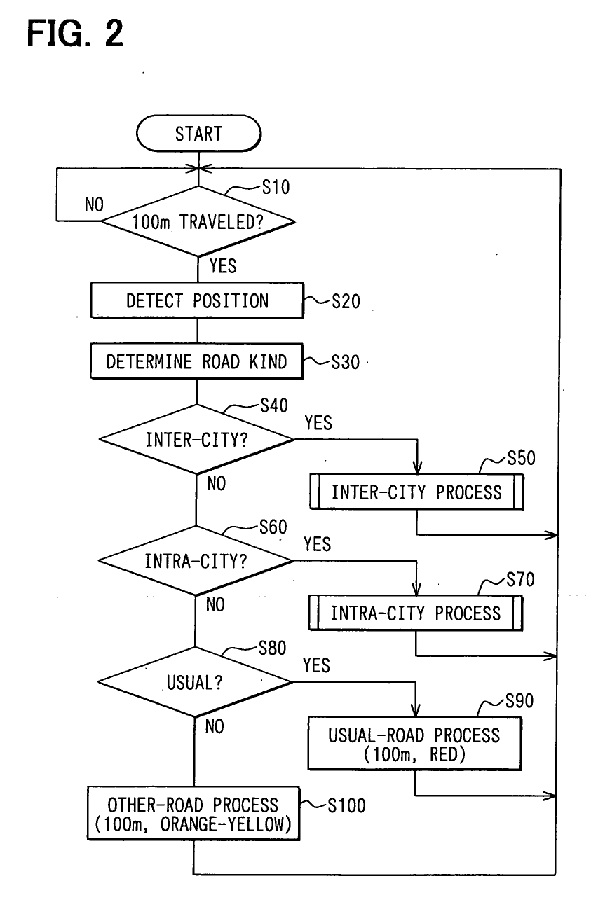

Next, a process relating to traveled point displaying executed in the navigation device will be explained with reference to flowcharts in FIGS. 2 to 4.

The process in FIG. 2 is executed when power supply is started to the navigation device 1. At Step S10, it is determined whether a traveling distance reaches 100 m. This traveling distance is computed based on positional variations by obtaining with given time intervals current positions (pairs of longitude and latitude) detected by the position detector 2. Each time the traveling distance reaches 100 m (S10: YES), processes at Step S20 and subsequent steps take place.

At Step S20, a traveling position at this moment is detected based on the current position (longitude and latitude) detected by the position detector 2. At Step S30, a road kind of a road that the subject vehicle is currently traveling is determined based on road kind information included in the map data obtained from the map data storing unit 3. Here, the road kinds include an inter-city expressway (e.g., Tomei (Tokyo-Nagoya) Expressway or Meishin (Nagoya-Kobe) Expressway) that intermediates between big cities; an intra-city expressway (e.g., Shuto (Metropolitan) Expressway, Nagoya Expressway, or Hanshin Expressway); a usual road such as a national road and a prefectural road; and others. The others include places where no road are present and narrow roads that are not described in the map data.

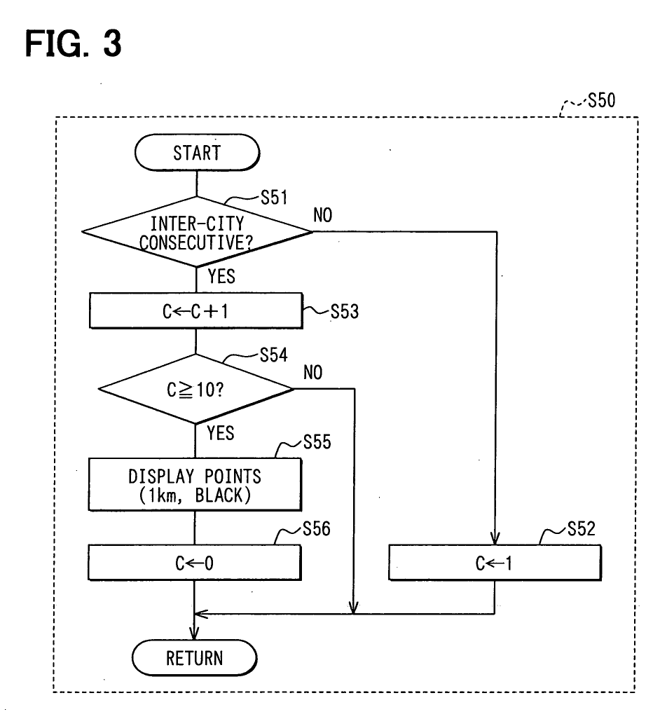

When the road kind is an inter-city expressway (S40: YES), the sequence goes to Step S50, where an inter-city-expressway traveled point displaying process takes place. This will be explained later with reference to FIG. 3.

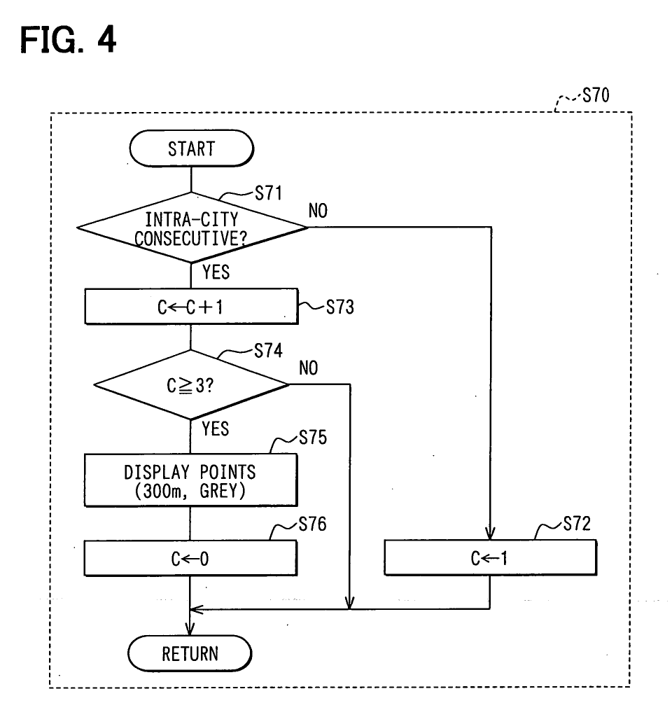

When the road kind is not an inter-city expressway (S40: NO), but an intra-city expressway (S50: YES), the sequence goes to Step S70, where an intra-city-expressway traveled point displaying process takes place. This will be explained later with reference to FIG. 4.

When the road kind is not an intra-city expressway (S50: NO), but a usual road (S80: YES), the sequence goes to Step S90, where a usual-road traveled point displaying process takes place.

When the road kind is not a usual road (S80: NO), the sequence goes to Step S100, where an other-road traveled point displaying process takes place.

After executing processes at Step S50, S70, S90, S100, the sequence returns to S10.

Next, displaying processes at Step S50, S70, S90, S100 will be explained sequentially.

FIG. 3 shows the inter-city-expressway traveled point displaying process at Step S50. When this process starts, at Step S51, it is determined whether the road kind determined in the immediately-previous determination is “inter-city-expressway.” Namely, it is determined whether the road kind is determined to be “inter-city-expressway” in the immediately-previous determination at Step S30 in FIG. 2 similarly in the current determination at Step S30. When the road kind is determined to be not “inter-city-expressway” in the immediately-previous determination (S51: NO), the current determination of “inter-city-expressway” becomes first. The sequence thereby goes to Step S52, where a counter C is set to “1.” The process routine then ends to return to Step S10 in FIG. 2.

In contrast, when the road kind is determined to be “inter-city-expressway” in the immediately-previous determination (S51: YES), the counter C is incremented (C⇄C+1) at Step S53. Then it is determined whether the counter C becomes 10 or more than 10 at Step S54.

When the counter C is less than 10 (S54: NO), this process routine ends to return to Step S10 in FIG. 2 without executing processes at Steps S55, S56. In contrast, when the counter C is 10 or more than 10 (S54: YES), the sequence goes to Step S55, where the traveled point is displayed. Here, a mark of the traveled point is shown on the map in a 1-km interval in black. A road kind of an on-traveling road that the subject vehicle is traveling is determined every 100-m traveling at Step S30. Therefore, when this determination is consecutively repeated in ten times (i.e., inter-city expressway is traveled continuously for 1 km), the determination at Step S54 is affirmed. The traveled point is then displayed at Step S55. At Step S56, the counter C is reset (C⇄0), and this process routine ends.

FIG. 4 shows the intra-city-expressway traveled point displaying process at Step S70. When this process starts, at Step S71, it is determined whether the road kind determined in the immediately-previous determination is “intra-city-expressway.” Namely, it is determined whether the road kind is determined to be “intra-city-expressway” in the immediately-previous determination at Step S30 in FIG. 2 similarly in the current determination at Step S30. When the road kind is determined to be not “intra-city-expressway” in the immediately-previous determination (S71: NO), the current determination of “intra-city-expressway” becomes first. The sequence thereby goes to Step S72, where a counter C is set to “1.” The process routine then ends to return to Step S10 in FIG. 2.

In contrast, when the road kind is determined to be “intra-city-expressway” in the immediately-previous determination (S71: YES), the counter C is incremented (C⇄C+1) at Step S73. Then it is determined whether the counter C becomes 3 or more than 3 at Step S74.

When the counter C is less than 3 (S74: NO), this process routine ends to return to Step S10 in FIG. 2 without executing processes at Steps S75, S76. In contrast, when the counter C is 3 or more than 3 (S74: YES), the sequence goes to Step S75, where the traveled point is displayed. Here, a mark of the traveled point is shown on the map in a 300-m interval in grey. A road kind of an on-traveling road is determined every 100-m traveling at Step S30. Therefore, when this determination is consecutively repeated in three times (i.e., intra-city expressway is traveled continuously for 300 m), the determination at Step S74 is affirmed. The traveled point is then displayed at Step S75. At Step S76, the counter C is reset (C⇄0), and this process routine ends.

Next, in a usual-road traveled point displaying process at Step S90, marks of traveled points are shown in 100-m intervals in red. A road kind of an on-traveling road is determined every 100-m traveling at Step S30. Therefore, in this process at Step S90, unlike in the processes in Steps S50, S70, the determinations regarding the counter C is removed, so traveled points are shown each time the sequence moves to Step S90.

Then, in an other-road traveled point displaying process at Step S100, marks of traveled points are shown in 100-m intervals in orange-yellow. Here, the other-road traveled point displaying process displays traveled points on other roads and off-roads. A road kind of an on-traveling road is determined every 100-m traveling at Step S30. Therefore, in this process at Step S90, unlike in the processes in Steps S50, S70, the determinations regarding the counter C is removed, so traveled points are shown each time the sequence moves to Step S100.

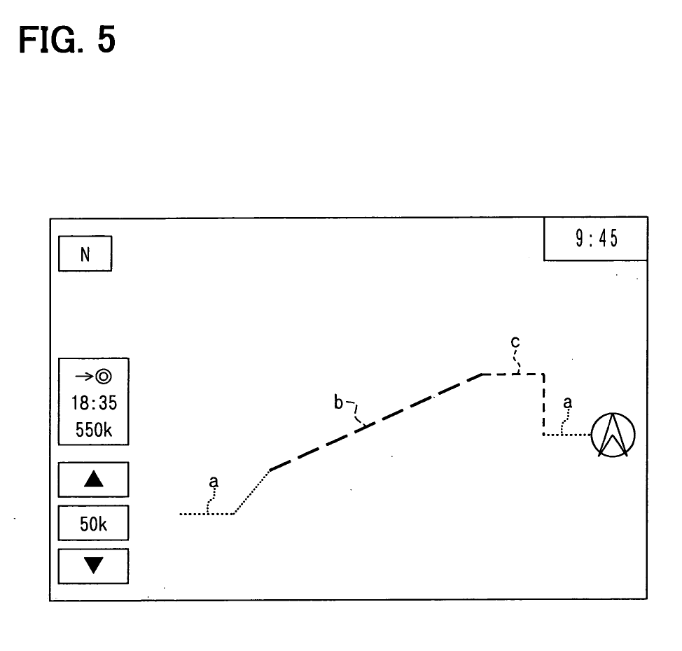

FIG. 5 shows an example of a result of a traveled point displaying process. In FIG. 5, three kinds a, b, c of traveled points are shown in an order of traveled point a⇄traveled point b⇄traveled point c⇄traveled point a. The traveled points a are of a usual road and shown in 100-m intervals in red. The traveled points b are of an inter-city expressway and shown in 1-km intervals in black. The traveled points c are of an intra-city expressway and shown in 300-m intervals in grey.

(Effects of Embodiment)

The navigation device 1 of the embodiment conducts a traveled point displaying process, where a traveled point is shown using a display color and a display interval according to a road kind of an on-traveling road. Therefore, which road kind the subject vehicle travels can be recognized at a glance by seeing the display color and the display interval.

Further, in the embodiment, colors of marks of traveled points are designed to enable easy recognition of the road kinds in consideration of road colors on map. For instance, since expressways are shown in blue, traveled points of the inter-city expressways are shown in black while traveled points of the intra-city expressways are shown in grey. Here, black and grey are similar colors, so that it is visually recognized that an inter-city expressway and an intra-city expressway belongs to the same “expressway.” In contrast, usual roads are shown in red; other roads and off-roads are shown in orange-yellow. Therefore, these other roads and the off-roads can be distinguished from “expressway” at a glance.

Further, not only colors but also intervals are differentiated depending on the road kinds. For instance, while traveled points in a usual road are shown in 100-m intervals, traveled points in an inter-city expressway are shown in 1-km internals, so a memory size for temporarily storing traveled points can be decreased to one tenth. Further, intervals of the traveled points also easily indicate the road kind.

There is a technology where a display interval is changed based on a vehicle speed. In this technology, traffic congestion causes the display interval of the traveled point to be shorten, which has no effect in decreasing the memory size. For instance, a display interval even on an expressway, becomes smaller than that on a usual road depending on a degree of traffic congestion. Therefore, only seeing display intervals dose not teach which road kind an on-traveling road belongs to. In contrast, in the embodiment of the present invention, regardless of traveling speeds, display colors and display intervals of traveled points vary depending on road kinds of on-traveling roads. A user who sees the traveled points displayed can easily recognize which road kind the subject vehicle travels.

(Others)

(1) In the above embodiment, when a display form of a traveled point is changed, a display color and a display interval are changed in a traveled point. However, either a display color or a display interval can be changed. Further, a traveled point can be changed in a size, a shape, or the like. However, changing a display color and a display interval, as explained in the embodiment, suffices for enabling a user to recognize a difference in a display form.

Further, a display color can be changed based on an operation by a user via the switching information input unit 4. Namely, the user can select a favored color of a traveled point.

(2) In the above embodiment, the road kinds include four kinds of an inter-city expressway, an intra-city expressway, a usual road, and other roads. However, they can be roughly grouped as an expressway and a usual road. Further, a usual road can be divided into a national road and a prefectural road. Furthermore, a road kind is one of road attributes, so a display form can be changed by another attribute other than the road kind. For instance, a lane number can be used for this purpose by differentiating it by a one-lane road, a two-lane road, and a road of three or more lanes. Even in selecting a road attribute for this purpose, it can be designed for a user to select it via the switching information input unit 4.

(3) The traveled point displaying process can be achieved as a program that is stored in a computer-readable medium such a flexible disk, a magnetooptic disk, a CD-ROM, a hard disk, a ROM, or a RAM. This program can be loaded to a computer when needed and then activated. Further, this program can be downloaded via a network.

It will be obvious to those skilled in the art that various changes may be made in the above-described embodiments of the present invention. However, the scope of the present invention should be determined by the following claims.

1. A traveled point display device provided in a vehicle, the device comprising:
a road map storing unit that stores map data that includes a road attribute including a kind of a road, and a lane number of the road;
a displaying unit that displays a road map based on the map data;
a traveled point detecting unit that detects a traveled point of the vehicle; and
a display controlling unit that changes a display form of the traveled point based on the road attribute so that the road attribute is visually distinguished and causes the display unit to display the traveled point in the display form changed.

2. The traveled point display device of claim 1,
wherein the display controlling unit changes at least a display interval of the traveled point.

3. The traveled point display device of claim 1,
wherein the display controlling unit changes at least a display color of the traveled point.

4. The traveled point display device of claim 1,
wherein the display controlling unit changes the display form of the traveled point so that the kind of the road is distinguished.

5. The traveled point display device of claim 1,
wherein the display controlling unit changes the display form of the traveled point so that the lane number of the road is distinguished.

6. The traveled point display device of claim 1, further comprising:
an accepting unit that accepts a manipulation by a user,
wherein the display controlling unit that
designates a target road attribute based on the manipulation by the user, and
changes the display form of the traveled point so that the target road attribute designated is visually distinguished.

7. The traveled point display device of claim 6,
wherein the display controlling unit that
designates a correspondence relationship between the target road attribute and the display form of the target road attribute based on the manipulation by the user, and
changes the display form of the traveled point based on the correspondence relationship designated.

8. A computer program product in a computer-readable medium for use in a traveled point displaying device in a vehicle that includes:
a road map storing unit that storing map data that includes a road attribute including a kind of a road, and a lane number of the road;
a displaying unit that displays a road map based on the map data; and
a traveled point detecting unit that detects a traveled point of the vehicle;
the product comprising:
instructions for changing a display form of the traveled point based on the road attribute so that the road attribute is visually distinguished; and
instructions for causing the displaying unit to display the traveled point in the display form changed.

9. A traveled point displaying method used in a vehicle that includes:
a road map storing unit that storing map data that includes a road attribute including a kind of a road, and a lane number of the road;
a displaying unit that displays a road map based on the map data; and
a traveled point detecting unit that detects a traveled point of the vehicle;
the method comprising steps of:
changing a display form of the traveled point based on the road attribute so that the road attribute is visually distinguished; and
causing the displaying unit to display the traveled point in the display form changed.
